(19) United States
(12) Patent Application Publication
(10) Pub. No.: US 2013/0283051 A1
(43) Pub. Date: Oct. 24, 2013

(54) Persistent License for Stored Content

(71) Applicant: Microsoft Corporation, Redmond, WA (US)

(72) Inventors: Daniel J. Zigmond, Menlo Park, CA (US); Peter T. Barrett, San Francisco, CA (US); John H. Grossman, IV, Fremont, CA (US); Dustin L. Green, Redwood City, CA (US)

(21) Appl. No.: 13/841,264

(22) Filed: Mar. 15, 2013

Related U.S. Application Data
(63) Continuation of application No. 10/782,678, filed on Feb. 19, 2004.

(51) Int. Cl. H04L 29/06

(52) U.S. Cl. CPC H04L 63/0428
USPC 713/168

(57) ABSTRACT

In an implementation, a method includes forming a request by a client for communication to a licensing server. The request is for storing encrypted content by the client. A persistent license is received at the client in response to the request. The persistent license includes a key that is encrypted. The key, when decrypted, provides access to the encrypted content. The key is configured to be decrypted by the licensing server. The client, however, is not configured to decrypt the key from the persistent license. The persistent license and the encrypted content are stored by the client.

### RELATED APPLICATIONS

This application is a continuation of and claims priority to U.S. patent application Ser. No. 10/782,678 filed Feb. 19, 2004, the disclosure of which is incorporated by reference herein in its entirety.

### BACKGROUND

Users have access to a wide range of content from a variety of sources. Wide availability of content, such as software and digital media, and easy access to the content through the Internet has resulted in unintended and unauthorized use of the content. To protect content, Digital Rights Management (DRM) may be employed to manage rights for content from creation to consumption and to protect content from illegal accesses or copying. DRM may utilize encryption such that the content is encrypted and then distributed. Therefore, a user who desires to output the encrypted content must first obtain permission to access the content and a key for decrypting the encrypted content, which may be provided in a license. In this way, DRM enforces the proper usage of the content through use of the license.

One technique utilized to provide content from a content provider to a user is by streaming the content over a network for rendering. The user may then interact with the rendered data, such as by watching a movie, listening to a song, and so on. Streaming content provides increased functionality to a user such that the user may quickly receive the content. Without streaming, if the entire amount of the content was needed to be received from a content provider before it was output by a client, the user may experience a delay in rendering the content at a client, such as a computer, set-top box, and so on. By streaming the content, the delay encountered by the user may be lessened. In one example, content streaming is used to provide “real-time” rendering of content.

As previously stated, content may be encrypted to control access to the content. Encrypting content to be streamed, however, may be computationally intensive and therefore may consume significant resources if real-time streaming of the content is desired. Therefore, traditional DRM techniques utilized to protect streaming content were limited by the amount of computational resources available, the amount of content to be protected, and the number of users desiring access to the content.

Additionally, traditional DRM techniques employed block ciphers to encrypt the content. In some instances, keys used to decrypt the content were traditionally implemented in hardware of the client, e.g. a secure microcontroller, such that the keys were inaccessible to software. In this way, the keys could not be obtained by another client, thereby protecting the encrypted content from unauthorized access. Although the encrypted content could be stored, output of the encrypted content was limited to the particular client because only that particular client had the key, implemented in hardware, to decrypt the encrypted content.

Accordingly, there is a continuing need for digital rights management that provides for storage and output of encrypted content by a variety of devices.

### SUMMARY

Digital rights management (DRM) is described which provides a persistent license for stored content. Digital rights management may be provided through use of a licensing server that supplies one or more licenses to a client that may be utilized for accessing the content. The licenses may provide for hierarchical management of content access by the licensing server. The licensing server, for instance, may specify access rights for a particular item of content in a content license. The licensing server may control access to the content licenses through use of a boundary license, which may be utilized to access a plurality of content licenses. Therefore, the licensing server may specify access rights for a collection of content through use of the boundary license. Additionally, a session license may specify access for a client during a session initiated between the client and the licensing server. Thus, the session license may specify access rules of the client across different “boundaries” that are specified by each of a plurality of boundary licenses.

The licensing server may provide for storage and protection of stored content through use of a persistent license. For example, when a client desires access to stored content, the client communicates the persistent license to the licensing server. The licensing server may then verify whether the client is authorized to access the content. If the client is authorized, the licensing server communicates a license that includes a key that was obtained from the persistent license by the licensing server. The key is provided by the licensing server such that the client may access the content. The persistent license may be configured as a content, boundary or session license to provide access to varying collections of the content described by the respective license.

In an implementation, a method includes forming a request by a client for communication to a licensing server. The request is for storing encrypted content by the client. A persistent license is received at the client in response to the request. The persistent license includes a key that is encrypted. The key, when decrypted, provides access to the encrypted content. The key is configured to be decrypted by the licensing server. The client, however, is not configured to decrypt the key from the persistent license. The persistent license and the encrypted content are stored by the client.

In another implementation, a method includes forming a request by a client to access encrypted content. The request includes a persistent license for communication to a licensing server. The persistent license includes a key that is encrypted such that the key is not accessible by the client. A license is received in response to the request. The received license includes the key such that the key is accessible by the client. The key is for accessing the encrypted content.

### BRIEF DESCRIPTION OF THE DRAWINGS

FIG. 1 is an illustration of an exemplary implementation in which a digital rights management (DRM) system is shown

FIG. 2 is an illustration of an exemplary implementation in which a client and a license authority from the DRM system of FIG. 1 are shown in greater detail.

FIG. 3 is a flow chart depicting a procedure in an exemplary implementation in which the client outputs content that was encrypted by the content server through use of licenses obtained from the licensing server.

FIG. 4 is an illustration of an exemplary implementation in which licenses included in the client and licensing server of FIG. 3 are shown in greater detail.

FIG. 5 is an illustration of an exemplary implementation showing encrypted content that is streamed to the client of FIG. 3.

FIG. 6 is a flow chart depicting a procedure in an exemplary implementation in which the client outputs content included in different boundaries by obtaining boundary and content licenses for the content from the licensing server.

FIG. 7 is a flow chart depicting a procedure in an exemplary implementation in which the client stores content and outputs the stored content during a subsequent session that is initiated between the client and the licensing server.

FIG. 8 is a flow chart depicting a procedure in an exemplary implementation in which another client outputs content that was stored on the client of FIG. 7.

The same reference numbers are utilized in instances in the discussion to reference like structures and components.

### DETAILED DESCRIPTION

### Overview

Digital rights management utilizing persistent licenses for stored content is described. Digital rights management is provided by a licensing server through provision of one or more licenses to a client that may be utilized for accessing encrypted content. For example, the licensing server may provide a content license for accessing encrypted content. The content license, however, is encrypted utilizing a boundary key that is included in a boundary license. Likewise, the boundary license is encrypted with a session key that is included in a session license. In this way, the content, boundary and session licenses provide for hierarchical management of content access, e.g. a license hierarchy, by the licensing server. The licensing server, for instance, may specify access rights for a particular item of content in a content license, such as a television program that is streamed to the client. In another instance, a plurality of content licenses may be provided for segments of the stream, such as individual frames of the television program, and so on. The licensing server may control access to the content licenses through use of a boundary license, which may be utilized to access the plurality of content licenses. Therefore, the licensing server may specify access rights for a collection of content through use of the boundary license. For example, the boundary license may describe access rights to a television channel that includes a plurality of television programs. Additionally, the session license may specify access for a client during a session initiated between the client and the licensing server. Thus, the session license may specify access rules of the client across different “boundaries” that are specified by each of a plurality of boundary licenses. Although content, boundary and session licenses are described, a variety of different license hierarchies may be employed, such as a two-level hierarchy, a ten-level hierarchy, and so forth.

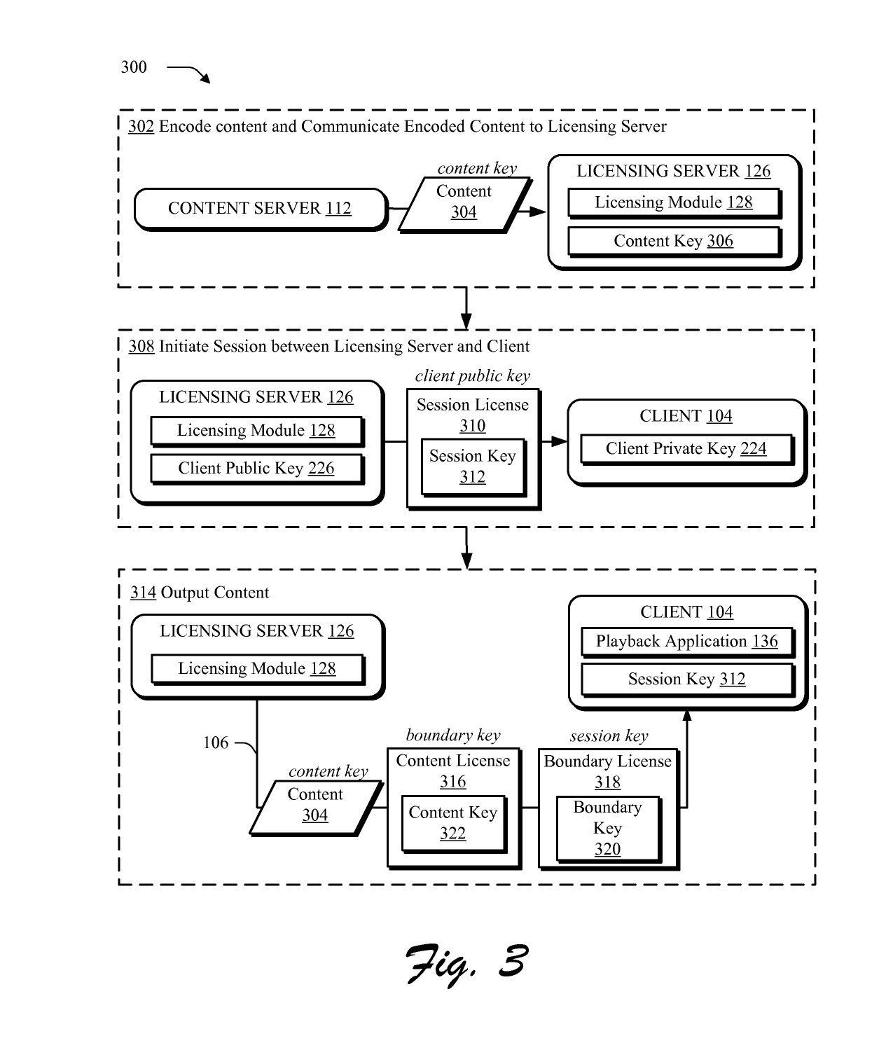

By providing for hierarchical management of content access, encryption algorithms may be employed at different “levels” of the license hierarchy that are optimized for the characteristics desired at that level of the hierarchy. For example, utilization of asymmetric and symmetric algorithms may have different computational complexities, and therefore utilize different respective amounts of computational resources. An asymmetric algorithm, for instance, may utilize a significantly greater amount of computational resources than a symmetric algorithm. Therefore, symmetric algorithms may be used at levels of the license hierarchy in instances in which lower amounts of computational resources are available and/or greater speeds are desired. Asymmetric algorithms may be used at levels of the license hierarchy in instances in which higher levels of computational resources are available. In additional implementations, symmetric and/or asymmetric algorithms may be employed having different computations complexities. For example, symmetric algorithms that have different computational complexities may be employed at different respective levels of the license hierarchy. Further discussion of asymmetric and symmetric encryption and decryption may be found in relation to FIGS. 3, and 6-8.

The licensing server may also provide for storage and protection of stored content through use of a persistent license. The persistent license may include one or more of the content, session, and boundary keys that are encrypted such that the client may not access the keys. The persistent license, however, may be decrypted by the licensing server to obtain the included keys. Therefore, when the client desires access to stored content, the client communicates the persistent license to the licensing server. The licensing server may then verify access rights of the client. If the client has rights to the content, the licensing server communicates a license that includes the key from the persistent license such that the client may access the content. In an implementation, the client may utilize the key to decrypt the content directly, i.e. the key is utilized to decrypt the content. In another implementation, the client may utilize the key to decrypt a content license to obtain a content key, which is then utilized to decrypt the content. In a further implementation, additional key hierarchies are employed to provide additional encryption.

### Environment

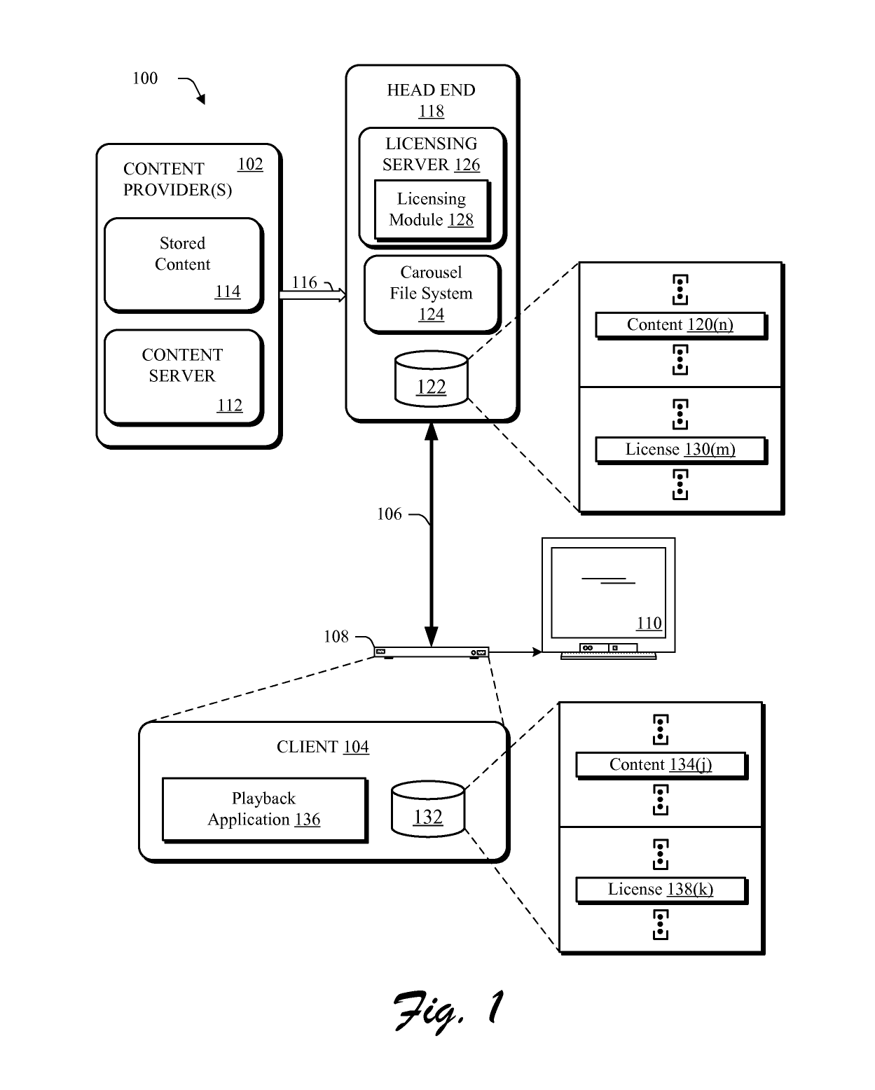

FIG. 1 is an illustration of an exemplary implementation showing an environment 100 in which content is communicated from a content provider 102 to a client 104 over a network 106. The client 104 may be configured in a variety of ways. For example, the client 104 may be configured as a computer that is capable of communicating over the network 106, such as a desktop computer, a mobile station, an entertainment appliance, a set-top box 108 communicatively coupled to a display device 110 as illustrated, a wireless phone, and so forth. The client 104 may range from a full resource device with substantial memory and processor resources (e.g., television enabled personal computers, television recorders equipped with hard disk) to a low-resource device with limited memory and/or processing resources (e.g., traditional set-top boxes). The client 104 may also relate to a person and/or entity that operates the client. In other words, client 104 may describe a logical client that includes a user and/or a machine. Although one client 104 is illustrated, a plurality of clients may be communicatively coupled to the network 106. The network 106 includes two-way communication such that the client 104 may communicate with the content provider 102. The network 106 may include a variety of networks that provide two-way communication, such as the Internet, an intranet, a wired or wireless telephone network, a broadcast network with a back channel, and so forth.

The content provider 102 includes a content server 112 and stored content 114. The stored content 114 may include a variety of data, such as television programming, video-on-demand (VOD), an electronic program guide (EPG), one or more results of remote application processing, and so on. The content server 112 provides content from the stored content 114 over a network 116 to a head end 118. The network 116 may be the same as or different from network 106. The content 120(n), where “n” can be any number from “1” to “N”, may then be stored in a database 122 on the head end 118 for broadcast over the network 106 to the client 104. The content 120(n) may also include additional data that is broadcast to the client 104. For example, the content 120(n) stored in the database 122 may include EPG data that is broadcast to the client 104 utilizing a carousel file system 124. The carousel file system 124 repeatedly broadcasts the EPG data over an out-of-band (OOB) channel to the client 104 over the network 106. Distribution from the head end 118 to the client 104 may be accommodated in a number of ways, including cable, RF, microwave, and satellite.

The head end 118 also includes a licensing server 126 to provide digital rights management of the content 120(n) for use by the client 104. The licensing server 126 may execute a licensing module 128 to control the provision of one or more of a plurality of licenses 130(m), where “m” can be any number from 1 to “M”, to the client 104. The licenses 130(m) provide access rights and decryption keys for accessing the content 120(n). In an implementation, one or more of the licenses 130(m) may be broadcast over the network 106 utilizing the carousel file system 124 so that the client 104 may access the content 120(n) which is broadcast over the network 106. In another implementation, the licenses 130(m) are transmitted over the network 106 that is configured as a digital subscriber line (DSL). Although the head end 118 is illustrated as separate from the content provider 102, the content provider 102 may also include the head end 118, the licensing server 126, and/or the content server 112.

The client 104 may be configured in a variety of ways to receive the content 120(n) over the network 106. For example, the client 104 may be configured as a set-top box 108, as illustrated, that is communicatively coupled to a display device 110. The client 104 includes hardware and software to transport, decrypt, decode, and output content 120(n) received from the head end 118 for rendering by the display device 110.

The client 104 may also include personal video recorder (PVR) functionality. The client 104, for instance, may include a storage device 132 to record content 120(n) received from the network 106 for output to and rendering by the display device 110. Content 134(j), where “j” can be any number from “1” to “J”, that is stored in the storage device 132 of the client 104 may be copies of content 120(n) that was received over the network 106 from the head end 118. Additionally, content 134(j) may be obtained from a variety of other sources, such as from a computer-readable medium that is accessed by the client 104, content that was captured by the client 104, and so on.

To output the content 120(n), 134(j), the client 104 may execute a playback application 136. The playback application 136, when executed by the client 104, may access one or more of a plurality of licenses 138(k), where “k” can be any number from “1” to “K”, to access the content 120(n), 134(j). For example, licenses 138(k) that are stored in the storage device 132 may be copies of licenses 130(m) that were received by the client 104 over the network 106. The licenses 130(m), 138(k) may include access rights and decryption keys for decrypting the content 120(n), 134(j) by the client 104, which is described in greater detail in the following implementation.

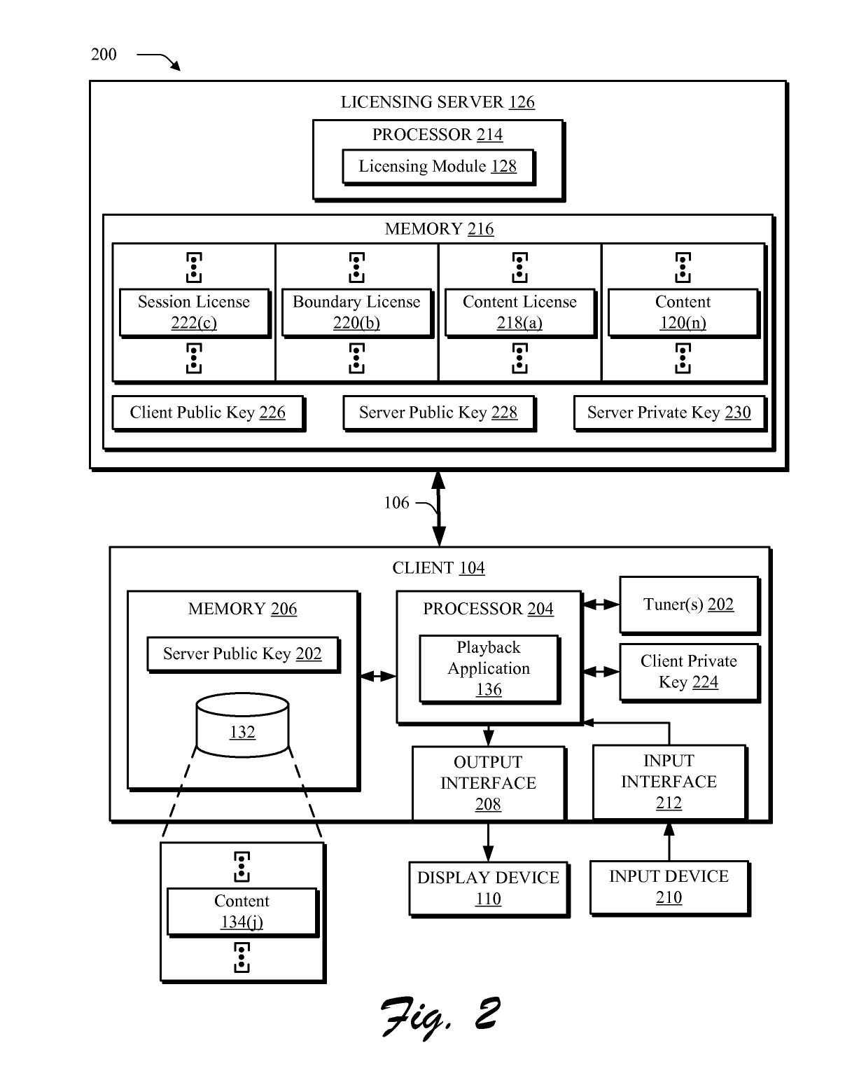

FIG. 2 is an illustration of an exemplary implementation 200 showing the licensing server 126 and client 104 of FIG. 1 in greater detail. The client 104 is capable of receiving content (e.g., movies, television shows, live events, commercials, newscasts, etc.) from one or more different sources as shown in FIG. 1. For example, the client may receive content broadcast by the head end 118 of FIG. 1 by using one or more tuners 202.

The client 104 stores the content 134(j) in the storage device 132 through execution of the playback application 136. The playback application 136 is illustrated as being executed on the processor 204 and is storable in memory 206. The memory 206 may be the same as or different from the storage device 132. For example, the storage device 132 may be configured as a hard disk drive and the memory 206 may be configured as RAM, both the memory 206 and the storage device 132 may be configured as RAM, both the memory 206 and the storage device 132 may be configured as removable memory, and so forth. The client 104, through execution of the playback application 136, is also capable of retrieving the content 134(j) from the storage device 132 and outputting the content 134(j) through an output interface 208 for rendering on the display device 110. Thus, in this implementation, the client 104 is capable of operating as a PVR that stores and plays back the content 134(j) in a manner akin to a video cassette recorder.

The client 104 may also provide additional functionality. The client 104, for instance, may be controlled by the viewer via inputs entered using an input device 210. By entering the inputs, the viewer can request recordation of particular content 134(j) and navigate through the content 134(j), such as to fast forward, rewind or pause the output of the content 134(j). The inputs entered by the viewer using input device 210 are received by the client 104 via an input interface 212. The client 104, for instance, may accept inputs entered by the viewer entered via a remote control. In other instances, the viewer may initiate the inputs using a keyboard, mouse, or other input device. The inputs may provide non-linear playback of the content 134(j) (i.e., time shift the playback of the content 134(j)) such as pause, rewind, fast forward, slow motion playback, and the like. For example, during a pause, the client 104 may continue to record the content 134(j) in the storage device 132. The client 104, through execution of the playback application 136, may then playback the content 134(j) from the storage device 132, starting at the point in time the content 134(j) was paused, while continuing to record the currently-broadcast content 134(j) in the storage device 132.

The licensing server 126 also includes a processor 214 and memory 216. The licensing module 128 is illustrated as being executed on the processor 214 and is storable in memory 216. The licensing module 128, which executed, may provide digital rights management to protect the content 120(n) from unauthorized use. For example, the licensing server 126 may provide content 120(n) for broadcast over the network 106. As was previously discussed, the licensing server 126 may receive the content 120(n) from the content provider 102 of FIG. 1. The content 120(n) is encrypted to ensure that the content 120(n) is accessed by authorized users, such as subscribers of the content provider 102. For example, the content 120(n) may be encrypted by the content provider 102 or the licensing server 126 such that if the content 120(n) is received by an unauthorized user, the unauthorized user may not access the content 120(n).

To provide access to the content 120(n), the license module 128 may be executed to generate the plurality of licenses 130(m) of FIG. 1. For example, the licensing module 128, when executed, may generate content licenses 218(a) for respective content 120(n). Each content license 218(a) may include access rules and a content key to decrypt respective content 120(n). Access rules may specify rights and privileges for accessing the content 120(n). The access rules may be expressed utilizing a variety of languages, such as XRML (eXtensible Rights Markup Language), XACML (eXtensible Access Control Markup Language), ODRL (Open Digital Rights Language), and the like.

To further protect the content 120(n), the licensing module 128, when executed, may also generate one or more boundary licenses 220(b). Each of the boundary licenses 220(b) includes a boundary key and access rules for “rights boundaries” for the content 120(n). For example, different boundary licenses 120(n) may be provided for each television channel that is broadcast by the head end 118 over the network 106 to the client 104. In another implementation, rights boundaries are also set for each television program on each television channel. In this way, the boundary licenses 220(b) may provide for additional management of digital rights of the content 120(n).

Session licenses 222(c) may also be generated by the licensing module 128 to further protect against unauthorized use of the content 120(n). For example, the licensing module 128 may generate a session license 222(c) for each session initiated between the licensing server 126 and the client 104. An example of a session includes each time the client 104 “logs on” to the licensing server 126. To further protect against unauthorized access, a new session and corresponding session license 222(c) may be generated at predetermined intervals of time, regardless of whether the client 104 “logged off” the licensing server 126. For instance, a new session may be automatically initiated every 24 hours to protect against a user from leaving a client “logged on” indefinitely.

The content licenses 218(a), boundary licenses 220(b) and session licenses 222(c) may each utilize certificates to protect the licensing server 126 from being impersonated by attackers. The certificate, for instance, may be utilized to verify credentials of the licensing server 126, such as through use of an identifier (ID) of the license authority, a digital signature of the certificate-issuing authority, and so on.

The content licenses 218(a), boundary licenses 220(b) and session licenses 222(c) provide a license hierarchy that provides various stages of control over the content 120(n). For example, the content 120(n) may be encrypted with a content key (not shown here). The content key is included in the content license 218(a), along with access rules and a content license identifier, which may be utilized to provide access to the content 120(n). To protect the content license 218(a) and the included content key from unauthorized access, the content license 218(a) may be encrypted with a boundary key (not shown here). A boundary license 220(b) is generated which includes the boundary key, access rules, and an identifier. Likewise, to protect the boundary license 220(b) and the included boundary key from unauthorized access, the boundary license 220(b) may be encrypted with a session key. The session key is included in the session license 222(c) along with access rules for the session. In this way, the licensing module 128 may provide for hierarchical digital rights management that may be specified for each item of content, each boundary, and each session. Additional discussion of the content, boundary and session licenses 218(a), 220(b), 222(c) may be found in relation to FIGS. 3, and 6-8.

The content, boundary and session keys may utilize a variety of encryption algorithms, such as symmetric and asymmetric encryption algorithms. Symmetric encryption algorithms utilize a single key to encrypt and decrypt data. Advanced Encryption Standard (AES) is one example of a symmetric encryption algorithm. Asymmetric encryption algorithms are utilized in public-key cryptography. Public-key cryptography employs a pair of “keys” which are referred to as a private key and a public key. Public-key cryptography uses either the public or private key at different steps of the encryption and decryption process. For example, public-key cryptography may utilize an asymmetric encryption algorithm to encrypt data and an asymmetric decryption algorithm to decrypt encrypted data. The asymmetric encryption algorithm uses the public key and original data to be encrypted to form the encrypted data, e.g. cipher text. The asymmetric decryption algorithm uses the private key in conjunction with the encrypted data to generate the original data. An example of an asymmetric encryption and decryption is known by the acronym “RSA” (Rivest, Shamir, & Adleman).

Utilization of asymmetric and symmetric algorithms may have different computational complexities, and therefore utilize different respective amounts of computational resources. For example, an asymmetric algorithm may utilize a significantly greater amount of computational resources than a symmetric algorithm. Therefore, in one implementation, asymmetric and symmetric algorithms are used at different respective levels of the license hierarchy based on desired performance at the respective level and on whether the server and client have already established a trust relationship via another level of the hierarchy or other means. For example, the session license 222(c) may be encrypted utilizing an asymmetric encryption algorithm and the content 120(n) encrypted with a symmetric algorithm. In this example, the use of the asymmetric encryption algorithm reflects a contemplated number of uses of the asymmetric encryption algorithm as opposed to the symmetric encryption algorithm by the client 104 in a particular setting and reflects the possibility that the server does not have a key to use for encrypting communication with the client prior to receiving the client's public key. For instance, the session license 222(c) may be decrypted once per session, while content may be constantly streamed to the client 104. Therefore, the client 104 may undergo the relatively resource intensive process of asymmetric decryption once per session, while utilizing relatively resource efficient symmetric decryption for the content 120(n). Further discussion of asymmetric and symmetric encryption and decryption may be found in relation to FIGS. 3, and 6-8.

In one implementation, the client 104 and the licensing server 126 respectively include a client private key 224 and a client public key 226. The client private key 224 is illustrated separate from the memory 206 to indicate that the client private key 224 is coded into the hardware of the client 104 and cannot be obtained from the client 104. Therefore, content encrypted with the client public key 226 may only be decrypted by the client 104 utilizing the client private key 224. In other implementations, the client private key 224 is storable in the memory 206.

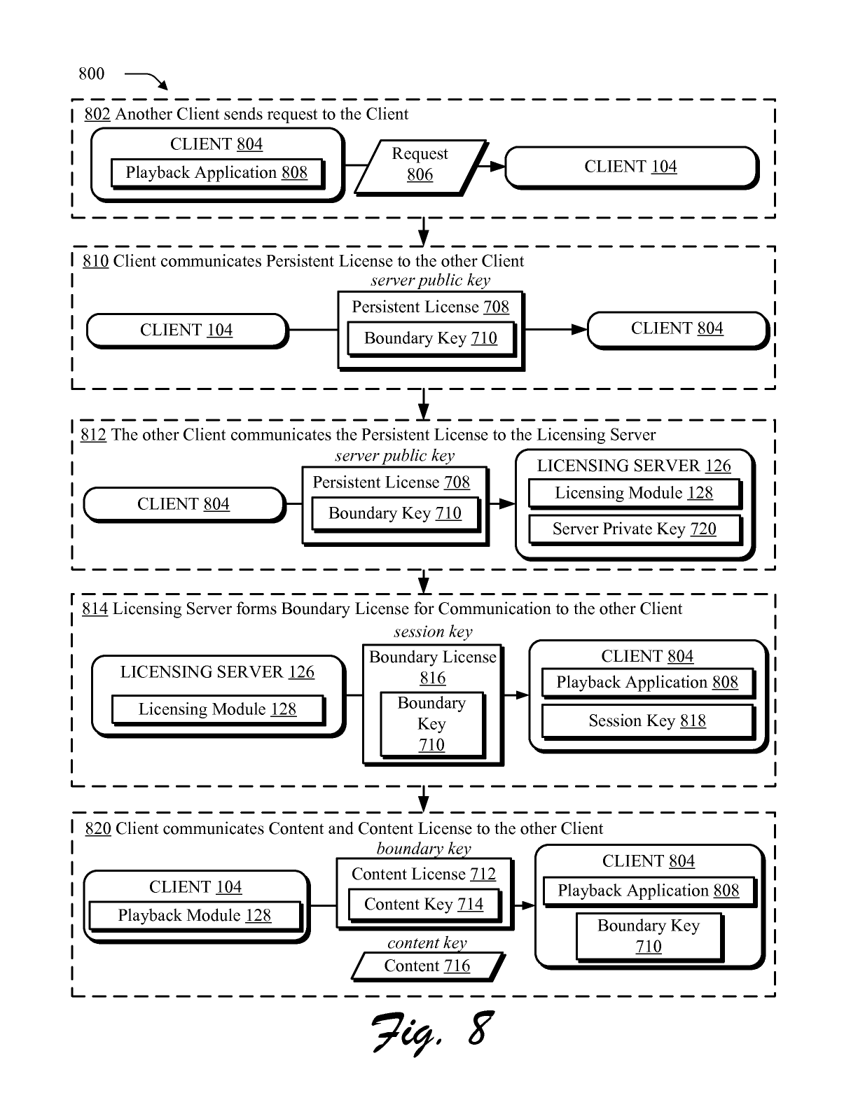

The licensing server 126 includes a server public key 228 and a server private key 230. The server public and private keys 228, 230 are used to provide asymmetric encryption such that the licensing server 126 is configured to encrypt and decrypt persistent licenses to the exclusion of other servers and the client 104. In other words, persistent licenses encrypted using the server public key 228 are decrypted using the server private key 230. Therefore, if the server private key 230 is limited to inclusion on the licensing server 126, the licensing server 126 is configured to decrypt the persistent license to the exclusion of other licensing servers, the content provider 102, and/or the client 104. Further discussion of an exemplary implementation in which the server public key 228, the server private key 230, and persistent licenses are utilized may be found in relation to FIGS. 7 and 8.

As previously stated, the content 134(j) may or may not correspond to the content 120(n) of the licensing server 126. When output of the content 134(j) is requested, the playback application 136 is executed on the processor 204 to retrieve the content 134(j). The playback application 136 may also decrypt the content 134(j) and examine access rules of the content, boundary and/or session licenses 218(a) 220(b), 222(c) to determine whether the client 104 is allowed to access the content 134(j). Further discussion of the use of content, boundary and/or session licenses 218(a) 220(b), 222(c) may be found in the following implementations.

FIG. 3 is a flow chart depicting a procedure 300 in an exemplary implementation in which the client 104 outputs content that was encrypted by the content server 112 through use of licenses obtained from the licensing server 126. At block 302, content 304 is encrypted by the content server 112 and a content key 306 is communicated to the licensing server 126. The licensing module 128 is executed on the licensing server 126 to store the content key 306 that may be utilized to decrypt the content 304. In this implementation, the content key 306 is provided by a symmetric encryption algorithm so that the content 304 may be decrypted in an efficient manner as previously discussed. To illustrate that the content 304 was encrypted using the content key 306, the words “content key” are depicted in italics above the content 304. Similar depictions of encryption are utilized in the following figures.

At block 308, a session is initiated between the licensing server 126 and the client 104. When the client 104 first authenticates itself with the licensing server 126, such as to “log on” to the licensing server 126, the client 104 receives a session license 310. The session license 310 acts as a basis for protecting communications between the licensing server 126 and the client during a session through use of a session key 312. In this implementation, the session key 312 is utilized in a symmetric encryption algorithm to encrypt and decrypt data. The session key 312 is included in the session license 310 for communication to the client 104 such that the client 104 may decrypt data encoded with the session key 312. The session license 310 may also include a description of access rights of the client 104 during the session, a license identifier to distinguish the session license 310 from other licenses, and a certificate to authenticate the session license 310. For example, the certificate may be utilized by the client 104 to verify that the session license 310 was obtained from the licensing server 126 to protect against attacks in which the licensing server 126 is impersonated. The certificate, for instance, may be utilized to verify credentials of the licensing server 126, such as through use of an identifier (ID) of the licensing server 126, a digital signature of the certificate-issuing authority, and so on. Therefore, through use of the certificate, the client 104 may determine whether the session license 310 is authentic.

The session license 310 is encrypted with the client public key 226 such that the client 104 may decrypt the session license 310 with the client private key 224. As was previously stated, the client private key 224 may be implemented in hardware on the client 104 such that the client private key 224 cannot be obtained from the client 104. By encrypting the session license 310 with the client public key 226, the session license 310 and the included session key 312 are protected against unauthorized access.

At block 314, content 304 is output by the client 104. In this implementation, the licensing server 126 streams content 304 to the client 104 over the network 106. The content 304 may also be provided by a variety of other sources as previously described. For example, in another implementation the content 304 is streamed from the content provider 102 to the client 104 over the network 106 without passing the content 304 through the licensing server 126. In further implementation, the content 304 is read by the client 104 from a computer-readable medium, such as a digital video disc (DVD).

The content 304 is encrypted with a content key. To provide access to the content 304, the licensing server 126 also communicated a content license 316 and a boundary license 318. The boundary license 318 is encrypted with the session key 312 and includes a boundary key 320. The boundary license 318 may also include a description of access rights of the client 104 for a rights boundary described by the boundary license 318, a license identifier to distinguish the boundary license 318 from other licenses, and a certificate to authenticate the boundary license 318. The content license 316 is encrypted with the boundary key 320 from the boundary license 318. The content license 316 includes a content key 322 that may be utilized to decrypt the content 304. The content license 316 may also include a description of access rights for the content 304, a license identifier, and a certificate to authenticate the content license 316.

The client 104 executes the playback application 136 to output the content 304 by first decrypting the boundary license 318 with the session key 312 to obtain the boundary key 320. The boundary key 320 is then utilized to decrypt the content license 316 to obtain the content key 322. The content key 322 is then utilized by the playback application 136 to decrypt the content 304 for output. In this implementation, the session key 312, boundary key 320 and content key 322 are each provided by respective symmetric encryption algorithms. Therefore, when the playback application 136 is executed on the client, the client may quickly decrypt the content 304, thereby promoting real-time streaming of the content 304 to the client 104. Additionally, through use of the client public key 226 and the client private key 224, the session key 312, boundary key 320 and content key 322 are further protected.

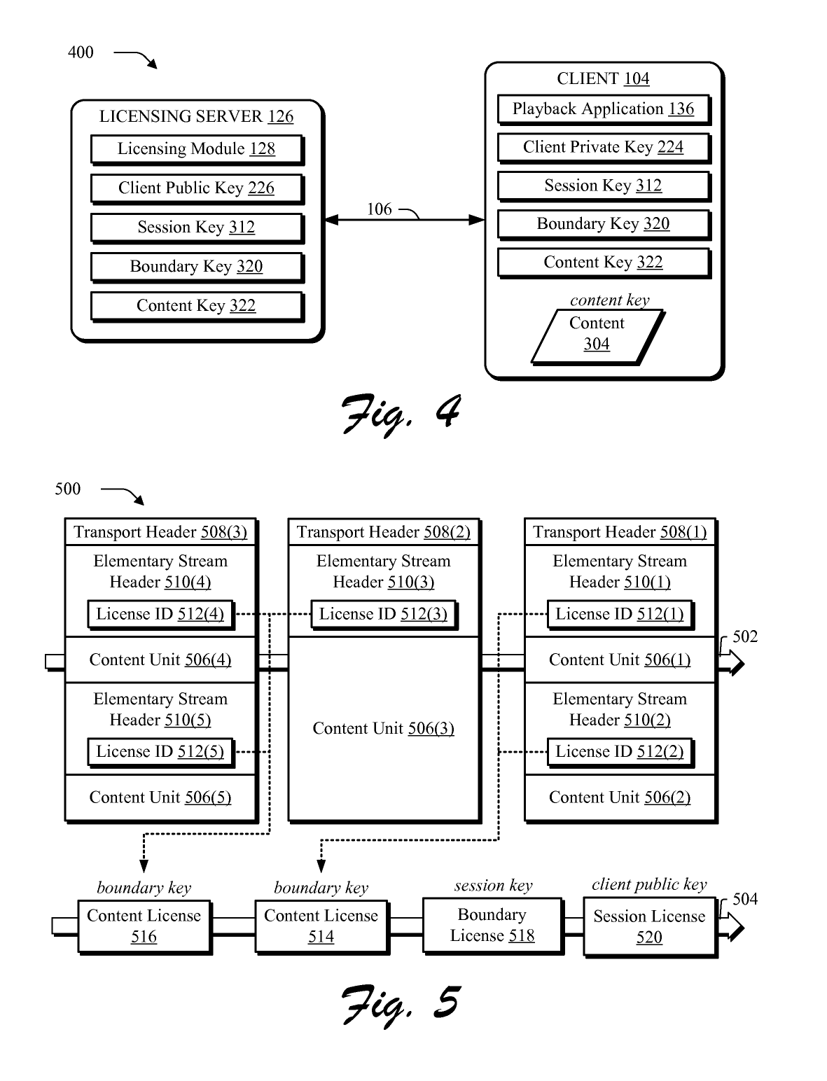

FIG. 4 is an illustration of an exemplary implementation 400 in which the client 104 and licensing server 126 of FIG. 3 are shown in greater detail. In this illustration, an arrangement is shown of the keys used for decryption and encryption by the licensing server 126 and the client 104. The keys provide for control of content 304 at a session level, boundary level, and content level as provided by the license hierarchy, as previously described.

The licensing server 126 and the client 104 each include a session key 312, a boundary key 320 and a content key 322. The content key 322 is utilized by the licensing server 126 or the content provider 102 of FIG. 1. or the content server 112 at block 302 of FIG. 3 to encrypt the content. The content key 322 is then utilized by the client 104 to decrypt the content 304. Thus, the content key 322 may be utilized to provide access to particular content 304, and therefore, through provision of the content key 322 by the licensing server 126, the licensing server 126 may manage access to the particular content 304.

Additionally, the licensing server 126 and the client 104 each include a boundary key 320 that it utilized to protect the content key 322. The boundary key 320 is utilized by the licensing server 126 to encrypt the content key 322, and therefore manage access to the content 304. For example, the content 304 may include a portion of a television program. The content key 322 may be provided to protect the content 304 from unauthorized access. To limit access to the content key 322, the boundary key 320 may be utilized to encrypt the content key 322. Additionally, the boundary key 320 may be utilized to encrypt other content keys that are included on a particular television channel. In other words, the rights boundary defined by the boundary key 320 is for a particular television channel. Therefore, in this example, the boundary key 320 may be utilized to provide access to content keys for a particular channel.

Further, the licensing server 126 and the client 104 each include a session key 312 that it utilized to protect the boundary key 320. Like the boundary key 320, the session key 312 may be utilized by the licensing server 126 to further manage access to the content 304. The session key 312 may be utilized to encrypt a boundary key 320 for each rights boundary that may be access by the client 104. Continuing with the previous example, the client 104 may access a plurality of television channels. Each television channel has a corresponding boundary key 320 that is used to decrypt the respective television channel. To enable the client 104 to access these channels, each boundary license 318 is encrypted with the session key 312. Therefore, the client 104 may access each of the channels by using the session key 312 to decrypt the boundary key 320, which is then utilized to decrypt the content key 322.

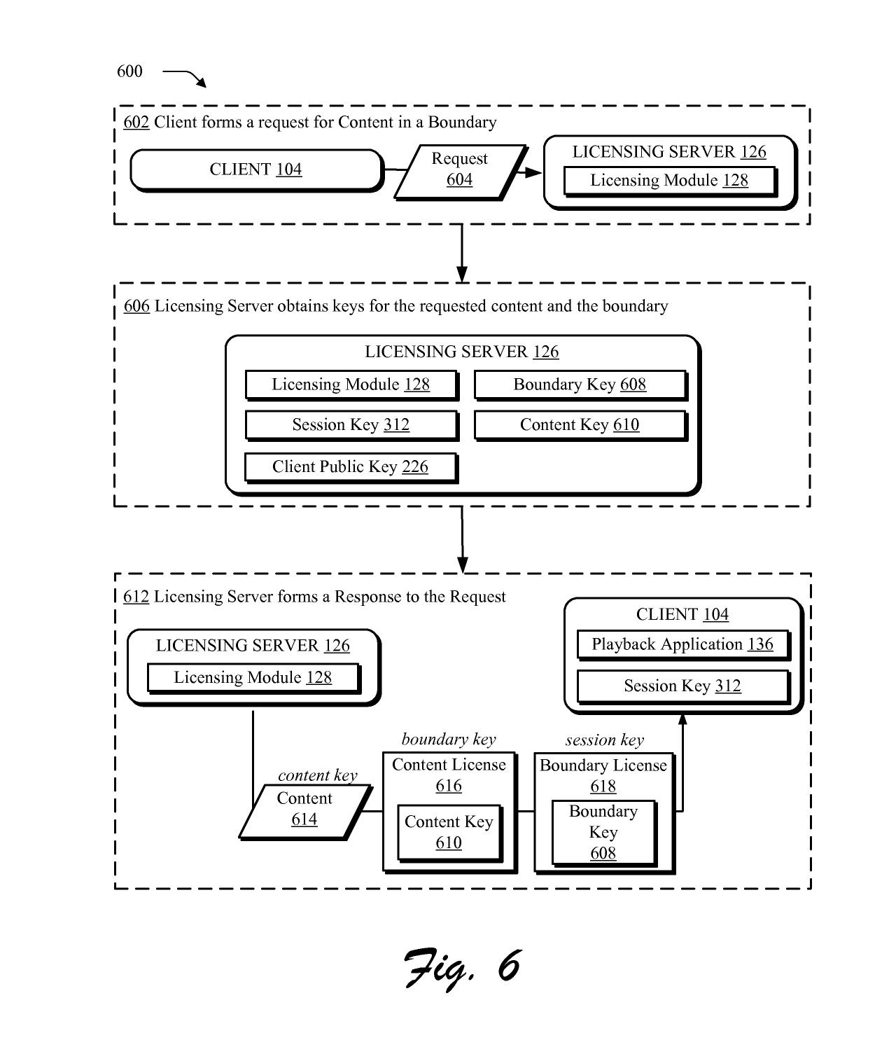

FIG. 5 is an illustration of an exemplary implementation 500 showing data that is streamed to the client 104 of FIG. 3. Data streamed to the client 104 is illustrated by a content stream 502 and a license stream 504. Although illustrated separately, the content and license streams 502, 504 may be provided as a single stream to the client 104.

In the content stream, each of the content units 506(1)-506(5) is encrypted. Each content unit 506(1) may be configured as a graphic, a portion of a television program, a portion of a song, a frame of a video, and so forth. Transport headers 508(1)-508(3) are included to provide routing and reconstruction of the content units 506(1)-506(5) when streamed to the client 104. Each of the content units 506(1)-506(5) includes a respective elementary stream header 510(1)-510(5). Each of the elementary stream headers 510(1)-510(5) includes a respective license ID 512(1)-512(5) to identify a corresponding license for the respective content units 506(1)-506(5). For example, license IDs 512(1)-512(2) correspond to content license 514 and license IDs 512(3)-512(5) correspond to content license 516, as illustrated by the respective dashed lines.

The license stream 504 provides licenses for decryption of the content units 506(1)-506(5). Content licenses 514, 516, for instance, may each include a respective content key for decrypting the respective content units 506(1)-506(5). Each of the content licenses 514, 516 are encrypted with a boundary key included in a boundary license 518, as illustrated by the italicized text “boundary key” above each of the content licenses 514, 516. The boundary license 518 is encrypted with a session key that is included in the session license 520, as shown by the italicized text “session key” illustrated above the boundary license 518. The session license 520 is encrypted using the client public key. The session license 520, therefore, may be decrypted by a client private key, such as the client private key 224 implemented as hardware as shown in FIG. 2. Therefore, the content, boundary and session licenses 514-520 may be streamed to the client 104 to enable the client to decrypt and output the content units 506(1)-506(5).

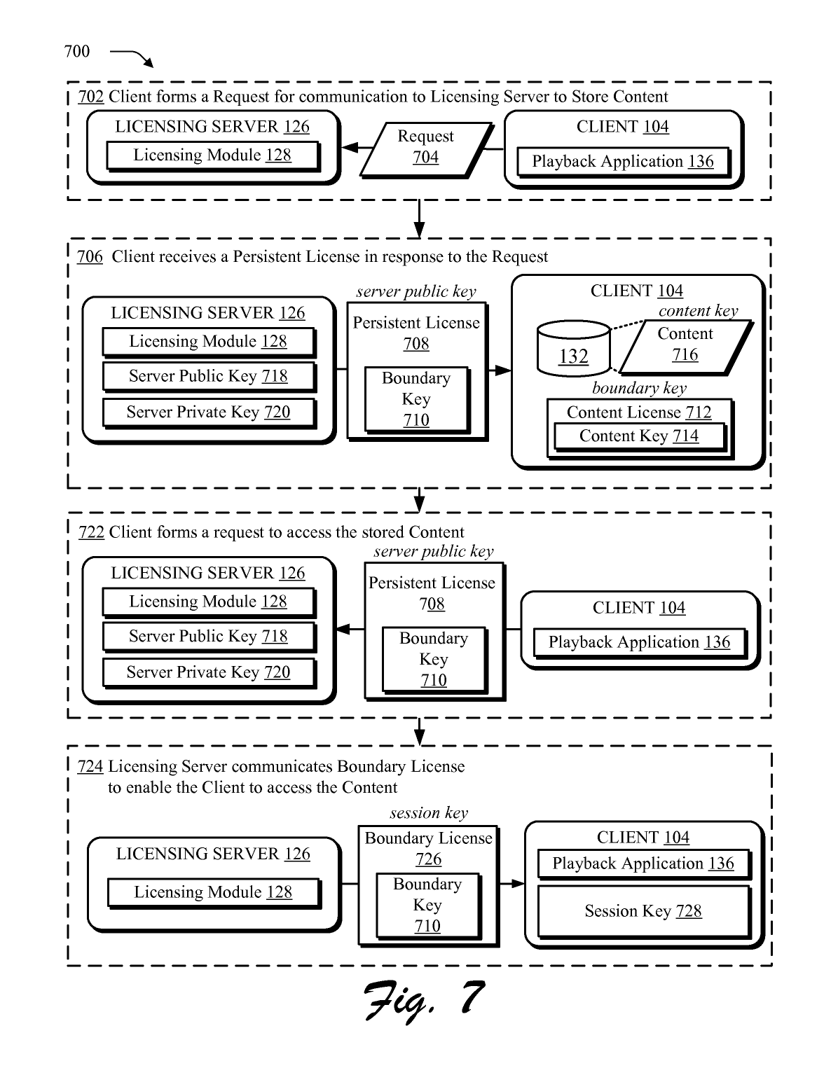

FIG. 6 is a flow chart depicting a procedure 600 in an exemplary implementation in which the client 104 outputs content protected by different boundary keys by obtaining boundary and content licenses for the content from the licensing server 126. As previously stated, rights boundaries may be defined based on a variety of considerations. For example, a rights boundary may be defined for each television channel of a television broadcast so that the licensing server 126 may manage access to the individual television channels. In another implementation, rights boundaries are defined for individual movies that are available from a video-on-demand (VOD) system. To provide access to content protected by a new boundary key, the licensing server 126 may provide a boundary license that contains that new boundary key. In this way, the client 104 may access content that is across a “rights boundary”.

At block 602, for example, the client 104 forms a request 604 for content protected by a boundary key. For instance, a user may utilize the input device 210 of FIG. 2 configured as a remote control to change from a currently viewed television channel that is output for display on the display device 110 to a different television channel. The request 604 may include an indication of the desired content and identification of the client 104 such that the licensing server 126 may determine whether the client 104 is authorized for access to the requested content.

At block 606, the licensing server 126 obtains keys for the requested content and the new boundary key. The licensing server 126 may then generate content and boundary licenses that include the respective keys. The licensing server 126, for instance, may create a boundary key 608 using a random number source. The random number source is a source of random data and may be configured in a variety of ways, such as a hardware random number generator.

The licensing server 126 may also obtain a content key 610 from the content provider 102 of FIG. 1 for the requested content. The licensing module 128, when executed, may then encrypt the content key 610 using the boundary key 608 to protect the content key 610 from unauthorized access.

At block 612, the licensing server 126 forms a response for communication to the client 104 that includes the requested content 614, a content license 616 and a boundary license 618. As previously stated in relation to block 314 of FIG. 3, the content 614 may also be provided from a variety of other sources. The content 614 is encrypted with the content key 610. The content key 610 is included in the content license 616 and is encrypted utilizing the boundary key 608. The boundary key 608 is included in the boundary license 618 that is encrypted with the session key 312. The boundary license 618 may be decrypted through execution of the playback application 136 by the client 104 using the session key 312. For example, at block 308 of FIG. 3, the client 104 initiated a session with the licensing server 126 and obtained the session key 312. Therefore, the playback application 136, when executed by client 104, may utilize the session key 312 to decrypt the boundary license 618 to obtain the boundary key 608. The playback application 136 is then executed to decrypt the content license 616 with the boundary key 608 to obtain the content key 610. The content key 610 is then utilized, through execution of the playback application 136, to decrypt the content 614 for output by the client 104. In an implementation, the session key 312, boundary key 608, and content key 610 are each used by a respective symmetric encryption algorithm.

In this implementation, the client 104 obtains access to the content 614 through use of the content license 616 and the boundary license 618. The boundary license 618 is decrypted through use of the session key 312 which was obtained from the session license 310 of block 308 of FIG. 3. Therefore, the playback application 136, when executed by the client 104, may output the content 614 during the session and while outputting content that is within the “boundary” defined by the boundary license 618.

Because the boundary license 618 is accessible through use of the session key 312, access to the content 614 in this implementation is limited to the session corresponding to the session key 312. To provide for storage of content such that the content may be accessed during a different session, a persistent license may be utilized. Through use of the persistent license, content may be stored by the client 104 and output during a different session, as is described in greater detail in the following implementation.

FIG. 7 is a flow chart depicting a procedure 700 in an exemplary implementation in which the client 104 stores content and outputs the stored content during a subsequent session that is initiated between the client 104 and the licensing server 126. At block 702, the playback application 136 is executed by the client 104 to form a request 704 for communication to the licensing server 126 to store content. The request 704 may include an indication of what content is to be stored and an identifier that identifies the client 104.

At block 706, the client 104 receives a persistent license 708 from the licensing server 126 in response to the request 704. The licensing module 128, for instance, may be executed by the licensing server 126 to generate the persistent license 708. The persistent license 708 includes a boundary key 710 that may be utilized to decrypt a content license 712. The content license 712 includes a content key 714 that may be utilized to decrypt the content 716. The boundary key 710, however, is not accessible by the client 104 from the persistent license 708. Rather, the persistent license 708 is encrypted with a server public key 718. The server private key 720 is not provided to the client 104. The persistent license 708 may be decrypted with a server private key 720, as will be described subsequently.

The content 716 is stored in the storage device 132 along with the content license 712 and the persistent license 708. Because the boundary key 710 is not accessible by the client 104, however, the content 716 may not be output by the client 104 until the boundary key 710 is made available to the client 104.

At block 722, the client 104 forms a request that includes the persistent license 708 for communication to the licensing server 126. The persistent license 708 includes the boundary key 710. In an implementation, the request is formed during the same session during which the content 716 was stored. In another implementation, the client 104 stores the content 716 during a first session. After a period of time passes, the client 104 may initiate a new session with the licensing server 126, and then forms the request.

The licensing server 126 receives the request and decrypts the persistent license 708 utilizing the server private key 720. The licensing server 126 may then determine whether the client 104 is authorized to output the stored content 716. For example, the licensing server 126 may request additional information from the client 104 regarding subscription rights to the content 716, may request payment information from the client 104, and so on.

At block 724, the licensing server 126 communicates a license to the client 104 that may be utilized by the client 104 to access the stored content 716. For example, the licensing server 126 may form a boundary license 720 that includes the boundary key 710. The boundary key 710 was utilized to encrypt the content license 712 that includes the content key 714 that was utilized to encrypt the content 716. Therefore, the playback application 136 may be executed by the client 104 to use the boundary key 710 to decrypt the content license 712 to obtain the content key 714. The content key may then be utilized to decrypt the content 716.

To enable the client 104 to access the boundary key 710 in the boundary license 726, the boundary license 726 is encrypted with a session key 728. The session key 728 may be generated during a new session that was initiated between the client 104 and the licensing server 126. Therefore, the boundary key 710 is protected against unauthorized access. Additionally, access rights of the client 104 with respect to the content 716 may be verified by the licensing server 126 to determine whether the client 104 is authorized to access the content 716 during the new session.

Although a persistent license 708 was described that included a boundary key 710 to obtain access to the stored content 716, the persistent license 708 may be configured in a variety of ways. For example, in the described implementation of FIG. 7, the persistent license 708 included a boundary key 710 to provide access to content license 712. Therefore, content licenses that were encrypted with the boundary key 710 may be decrypted by the client 104 using the boundary key 710, thereby permitting access to content corresponding to the content keys.

In another implementation, the persistent license 708 includes the content key 714. Therefore, in such an implementation, the persistent license 708 may be decrypted and the content key 714 provided so that the client 104 may access the particular content 716, but may not access other content that is encrypted using other content keys. In a further implementation, the persistent license 708 includes the session key 728. Therefore, the persistent license 708 in this implementation would provide access by the client 104 to content stored during a session corresponding to the session key 728. In this way, the persistent license 708 may be configured to provide access to different collections of content based on the key included in the persistent license 708. It should be noted that in the described implementation, because the key is included in the persistent license, the licensing server 126 does not need to keep a copy of the key to provide access to the content 716 at a later time. Rather, the client 104 provides for storage of keys that are utilized to access the content, and provides one or more of the keys to the licensing server 126 to be decrypted when access to the stored content is desired.

FIG. 8 is a flow chart depicting a procedure 800 in an exemplary implementation in which another client outputs content that was stored on the client 104 of FIG. 7. In the implementation described in relation to FIG. 7, the content was both stored and accessed by the same client 104 during different sessions through use of the persistent license 708. The persistent license 708 may also be utilized to provide access to the content by a different client. Therefore, the persistent license 708 provides for the sharing of stored content in a way that is still protected by the licensing server 126.

At block 802, another client 804 sends a request 806 to the client 104 for stored content. For example, the other client 804 may include a playback application 808 that is similar to the playback application 136 that was described in relation to FIG. 2. The other client 804 forms the request 806 for communication to the client 104 to receive the content 716 that was stored by the client 104 at block 706 of FIG. 7.

At block 810, the client 104 communicates the persistent license 708 to the other client 804. For instance, the client 104 may form a response for communication to the other client 804 that includes the persistent license 708 that was stored with the content 716 at block 706 of FIG. 7.

At block 812, the other client 804 communicates the persistent license 708 to the licensing server 126. As was previously described, the persistent license 708 includes the boundary key 710 that was encrypted using the server public key 718, as shown at block 722 of FIG. 7. Therefore, the licensing server 126 may execute the licensing module 128 and utilize the server private key 720 to decrypt the persistent license 708 to obtain the boundary key 710. The licensing server 126 may also determine whether the other client 804 is authorized to output the stored content 716. For example, the licensing server 126 may request additional information from the other client 804 regarding subscription rights to the content 716, may request payment information from the other client 804, and so on.

At block 814, the licensing server 126 forms a boundary license 816 that includes the boundary key 710 for communication to the other client 804. The boundary license 816 is encrypted using a session key 818 to protect the boundary license 816, and more particularly the boundary key 710, from unauthorized access. The other client 804 executes the playback application 808 to decrypt the boundary license 816 using the session key 818. When decrypted, the boundary key 710 is accessible by the playback application 808.

At block 820, the client 104, communicates the content 716 and the content license 712 to the other client 804. The playback application 808 is executed by the other client 804 to decrypt the content license 712 using the boundary key 710 to obtain the content key 714. The content 716 is then decrypted using the content key 714.

As shown in the current implementation, the persistent license 708 may provide access by another client 804 to content stored by the client 104, yet still protect the stored content from unauthorized access. Additionally, as previously described, although the persistent license 708 was described as including a boundary key 710, the persistent license 708 may be configured in a variety of ways. For example, the persistent license may also be configured to include a content key and/or a session key. Thus, the persistent license 708 may be configured to provide access to different collections of content to the other client 804 based on the key included in the persistent license 708.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
forming a first request for communication to a licensing server, wherein the first request is for storing encrypted content;
receiving a persistent license in response to the request, wherein the persistent license includes a boundary key;
storing the persistent license and the content;
forming a second request to access the encrypted content, wherein the second request includes the persistent license;
sending the second request to the licensing server;
receiving a boundary license in response to the second request, wherein the boundary license includes the boundary key;
decrypting the boundary license using a session key to obtain the boundary key;
decrypting a content license using the boundary key to obtain a content key; and
decrypting the encrypted content using the content key.

2. A method as described in claim 1, wherein the forming of:
the first request is performed by a first client; and
the second request is performed by a second client.

3. A method as described in claim 1, wherein the first and second requests are formed by a client.

4. A method as described in claim 1, further comprising at least one of decoding the decrypted content and outputting the decoded content.

5. A method as described in claim 1, wherein:
the persistent license was encrypted using an asymmetric encryption algorithm; and
the content, the boundary license, and the content license were encrypted using respective symmetric encryption algorithms.

6. One or more computer-readable media comprising computer-executable instructions that, when executed, perform the method as recited in claim 1.

7. A client comprising:
a processor; and
memory configured to maintain:
a persistent license including a key that is encrypted; and
a playback application that is executable on the processor to:
form a request to access encrypted content, wherein the request:
is for communication to a licensing server; and
includes the persistent license;
receive a response to the request that includes the key; and
access the encrypted content utilizing the key.

8. A client as described in claim 7, wherein the key is for decrypting the encrypted content.

9. A client as described in claim 7, wherein:
the memory is further configured to maintain a content license;
the key included in the persistent license is for decrypting the content license;
the content license includes a content key; and
the content key is for decrypting the encrypted content.

10. A client as described in claim 7, wherein:
the memory is further configured to maintain a content license;
the key included in the persistent license is for decrypting the content license;
the content license includes a content key;
the content key is for decrypting the encrypted content; and
the playback application is executable to:
decrypt the content license using the key to obtain the content key; and
decrypt the content using the content key.

11. A client as described in claim 7, wherein:
the memory is further configured to maintain a session license, a content license, and a client key;
the client key is for decrypting the session license;
the session license includes a session key for decrypting the response;
the response is a boundary license;
the key included in the response is a boundary key for decrypting the content license;
the content license includes a content key; and
the content key is for decrypting the encrypted content.

12. A client as described in claim 7, wherein:
the memory is further configured to maintain a session license, a content license, and a client key;
the client key is for decrypting the session license;
the session license includes a session key for decrypting the response;
the response is a boundary license;
the key included in the response is a boundary key for decrypting the content license;
the content license includes a content key;
the content key is for decrypting the encrypted content; and
the playback application is executable to:
decrypt the session license using the client key to obtain the session key;
decrypt the boundary license using the session key to obtain the boundary key;
decrypt the content license using the boundary key to obtain the content key; and
decrypt the content using the content key.

13. A client as described in claim 7, wherein the playback application is further executable to:
form an initial request for:
communication to the licensing server; and
storing encrypted content by the playback application;
receive the persistent license in response to the initial request; and
store the encrypted content and the persistent license.

14. A client as described in claim 7, wherein the playback application is further executable to form a request to obtain the encrypted content from another client.

15. A client as described in claim 7, further comprising a tuner configured to receive the encrypted content when streamed over a network.

16. A client as described in claim 7, wherein the license includes a certificate for verifying the licensing server.

17. A system comprising:
a network;
a client including:
a persistent license having a key that is encrypted; and
a playback application that is executable to:
form a request to access encrypted content, wherein the request includes the persistent license;
receive a response to the request that includes the key; and
access the encrypted content utilizing the key; and
a licensing server including a licensing module that is executable to:
receive the request including the persistent license;
decrypt the persistent license to obtain the key; and
form the response that includes the key for communication to the client over the network.

18. A system as described in claim 17, wherein:
the client includes a content license;
the key included in the persistent license is for decrypting the content license;
the content license includes a content key; and
the content key is for decrypting the encrypted content.

19. A system as described in claim 17, wherein:
the client includes a content license;
the key included in the persistent license is for decrypting the content license;
the content license includes a content key;
the content key is for decrypting the encrypted content; and
the playback application is executable to:
decrypt the content license utilizing the key to obtain the content key; and
decrypt the content utilizing the content key.

20. A system as described in claim 17, wherein:
the client includes a session license, a content license, and a client key;
the client key is for decrypting the session license;
the session license includes a session key for decrypting the response;
the response is a boundary license;
the key included in the response is a boundary key for decrypting the content license;
the content license includes a content key; and
the content key is for decrypting the encrypted content.
